(19) United States
(12) Patent Application Publication
(10) Pub. No.: US 2018/0306915 A1
(43) Pub. Date: Oct. 25, 2018

(54) HOLOGRAPHIC AND SPOTLIGHT METAMATERIAL APERTURES FOR MICROWAVE AND MILLIMETER WAVE IMAGING AND METHODS OF USE

(71) Applicant: Duke University, Durham, NC (US)

(72) Inventors: David R. Smith, Durham, NC (US); Guy Lipworth, Durham, NC (US)

(73) Assignee: Duke University, Durham, NC (US)

(21) Appl. No.: 15/769,644

(22) PCT Filed: Nov. 14, 2016
(86) PCT No.: PCT/US2016/061926

§ 371 Date: Apr. 19, 2018

Related U.S. Application Data
(60) Provisional application No. 62/254,291, filed on Nov. 12, 2015.

(51) Int. Cl. G01S 13/90; H01Q 3/34; H01Q 15/00

(52) U.S. Cl. CPC G01S 13/90; H01Q 15/0086; H01Q 3/34

(57) ABSTRACT

Holographic and spotlight metamaterial apertures for microwave and millimeter wave imaging and methods of use are disclosed. According to an aspect, an imaging system includes metamaterial elements being spaced apart and configured to respond to an electromagnetic field for radiating in a predetermined pattern to illuminate a scene. The imaging system also includes one or more antennas configured to generate a signal for imaging based on the illuminated scene.

### CROSS REFERENCE TO RELATED APPLICATION

This application claims the benefit of and priority to U.S. Provisional Patent Application No. 62/254,291, filed Nov. 12, 2015 and titled HOLOGRAPHIC AND SPOTLIGHT METAMATERIAL APERTURES FOR MICROWAVE AND MILLIMETER WAVE IMAGING AND METHODS OF USE, the disclosure of which is incorporated herein by reference in its entirety.

### STATEMENT AS TO FEDERALLY SPONSORED RESEARCH

This invention was made with the support of the United States government under Federal Grant No. HSHQDC-12-C-00049 awarded by the Department of Homeland Security. The government has certain rights in the invention.

### TECHNICAL FIELD

The presently disclosed subject matter relates to imaging. Particularly, the presently disclosed subject matter relates to holographic and spotlight metamaterial apertures for microwave and millimeter wave imaging and methods of use.

### BACKGROUND

Conventional imaging systems use real or synthetic apertures to interrogate a scene. Synthetic apertures are formed physically scanning or moving a simple antenna over the aperture and acquiring measurements sequentially at each step. To accomplish this task an accompanying mechanical apparatus or vehicle is needed—adding undesired bulk and size to the device's form factor. Alternatively, the antenna can occupy the entire aperture and rely on some mechanism by which its field patterns can be reconfigured electronically. An example of such a system is a phase array, which must rely on numerous phase shifters, amplifiers, and accompanying hardware to control its radiation pattern.

To address these issues, a frequency-diverse metamaterial aperture has been developed in the form of a leaky-wave antenna with resonant metamaterials serving as irises. This antenna is able to generate complex radiation patterns suited for computational-imaging schemes by sweeping its operation frequency, obviating the need for moving parts or extraneous amplifiers and phase shifters. However, without the ability to holographically control its radiation patterns, the fields radiating from such a system are pseudo-random and the diversity of their radiation patterns is limited by the resonators' quality-factor (Q). In addition, the resulting radiation patterns illuminate a large field of view (FOV) with little directivity. At high frequencies where the wavelength is short and resolution is high, interrogating a large FOV results in a prohibitively large data files and slow scene-reconstruction rates.

### BRIEF SUMMARY

Disclosed herein are holographic and spotlight metamaterial apertures for microwave and millimeter wave imaging and methods of use. According to an aspect, an imaging system includes metamaterial elements being spaced apart and configured to respond to an electromagnetic field for radiating in a predetermined pattern to illuminate a scene. The imaging system also includes one or more antennas configured to generate a signal for imaging based on the illuminated scene.

### BRIEF DESCRIPTION OF THE SEVERAL VIEWS OF THE DRAWINGS

The foregoing aspects and other features of the present subject matter are explained in the following description, taken in connection with the accompanying drawings, wherein:

FIG. 1 is a graph showing amplitude (normalized) and phase of a lorentzian resonator as a function of the operation frequency ω;

FIG. 2 is a graph showing the magnitude of a lorentzian dipole's polarizability as a function of its phase;

FIG. 3 are images showing an example of a fabricatable hologram constructed using lorentzian dipoles to produce a specific irradiance pattern;

FIG. 4 is a graphical depiction of example steps that may be taken by a Gerchberg-Saxton (GS) algorithm in accordance with embodiments of the present disclosure;

FIG. 5 is an image showing nine metamaterial apertures including a sparse holographic array;

FIG. 6 are images showing desired and computed radiation patterns of a holographic sparse array with no constraints on the pixel's fields;

FIG. 7 are images showing sparse holographic array with binary on/off elements and a cylindrical reference wave;

FIG. 8 are images demonstrating that a spare holographic array with on/off binary elements can move a localized radiation pattern to a different location in the scene without using any mechanically-moving parts;

FIG. 9 is an image showing that in the context of a metamaterial imaging system, the spotlight imager can be used in conjunction with other approaches to achieve a multi-sensor configuration;

FIG. 10 is a schematic diagram of an example spotlight imaging W-band system in accordance with embodiments of the present disclosure;

FIG. 11 are images showing usage of individual apertures as holograms in a spotlight imaging system;

FIG. 12A is a diagram of a sparse holographic imaging system in accordance with embodiments of the present disclosure;

FIG. 12B show the radiation pattern of each panel (phase normalized by magnitude) calculated around the origin 1 meter away;

FIG. 13A is a graph depicting the simulated target, lm away from the apertures, and having a vertical bar and a horizontal bar;

FIG. 13B is a graph depicting noiseless reconstructions from measurements utilizing nine transmitter apertures and sixteen receiver apertures; and

FIG. 13C is a graph depicting reconstructions in the presence of noise with 15 dB SNR.

### DETAILED DESCRIPTION

For the purposes of promoting an understanding of the principles of the present disclosure, reference will now be made to various embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element.

Unless otherwise defined, all technical terms used herein have the same meaning as commonly understood by one or ordinary skill in the art to which this disclosure belongs.

In accordance with embodiments, disclosed herein is an imaging system having a sparse set of apertures that collectively or independently form user-designed radiation patterns or modes. In one example, a coherent, holographic aperture is provided that can form modes with arbitrary variation over a designated region of interest. In another example, a “spotlight” illumination approach is used in which a subaperture forms a simple beam that restricts illumination of the target. Both of these examples can utilize dynamically controlled apertures to achieve imaging performance.

The imaging schemes described herein are considered in the context of metamaterial apertures, although the embodiments and examples provided herein should not be considered as limiting. In some embodiments, an array of metamaterial slots patterned into a parallel plate or linear waveguide are used to form the aperture. The metamaterial slots can behave as polarizable magnetic (electric) metamaterial elements that can respond to the local magnetic (electric) field within the waveguide and radiate from the guide with a known amplitude and phase, determined according to the resonator's lorentzian properties. The radiation pattern can be understood as a hologram, formed by the combination of the waveguide mode (or the reference wave) with the pattern of resonant metamaterial elements excited by the reference wave. A collection of resonating metamaterial elements, then can form a phase and/or amplitude hologram; an aperture including such elements can re-radiate the reference wave in a controlled fashion and form a variety of desired radiation patterns.

In accordance with embodiments, systems and techniques are disclosed by which a hologram can be designed using metamaterial elements serving as its “pixels”. In other embodiments, passive apertures are provided that rely solely on the frequency response of their metamaterial elements to generate frequency-diverse radiation patterns. In other embodiments, dynamically tunable apertures are provided that are configured to operate at a single frequency using binary or grayscale control of individual elements. These and other embodiments are described in further detail herein.

Depending on the frequency operation, a metamaterial fabrication process or technique can utilize a suitable printed circuit board (PCB) or photolithographic technique. Dynamic tuning of the metamaterials' response can be achieved with suitable packaged components, liquid-crystal technology, embedded semiconductor devices, or other suitable technology. Various simulations of holographically designed modes radiating from a sparse-array system are disclosed.

The present disclosure provides multiple holographic apertures working coherently in unison to form highly directive radiation patterns that illuminate small regions-of-interest on the target or scene and reconstruct reflective objects in those regions at faster rates. By relying on a holographic approach to design the apertures' radiation patterns as described herein, the system can illuminate the target or scene with measurement modes that are well-suited for computational imaging, resulting in improved imaging abilities. The holographic apertures can be configured such that they have a flat form-factor and a relatively low number of transmitters and receivers.

In accordance with embodiments, resonating metamaterial elements can serve as pixels in a hologram. The metamaterial elements can be realized in a variety of suitable ways as will be understood. For example, the metamaterial elements may be any suitable pattern of irises that are situated in a conducting plate. They may be suitable apertures or resonators, for example.

The behavior of the metamaterial elements may be modeled by treating them as dipoles with a dipole moment given by:

m̅ₙ=∝ₙH̅ₙ

where H̅ₙ is the local magnetic field at the location of the n^{th} dipole and ∝ is the dipole's polarizability. Note that while magnetic dipoles are assumed in this discussion, electric dipoles may also be utilized. The polarizability may be described using the lorentzian relationship:

$$∝ = \frac{F {ω}^{2}}{{ω}_{0}^{2} - {ω}^{2} + j ω γ}$$

where F is the oscillator's strength (set to 1 henceforth), ω=2Πf is the angular frequency, ω₀=2Πf₀ω₀=2Πf₀ is the resonance frequency, and Γ=ω₀/(2Q) is the loss term.

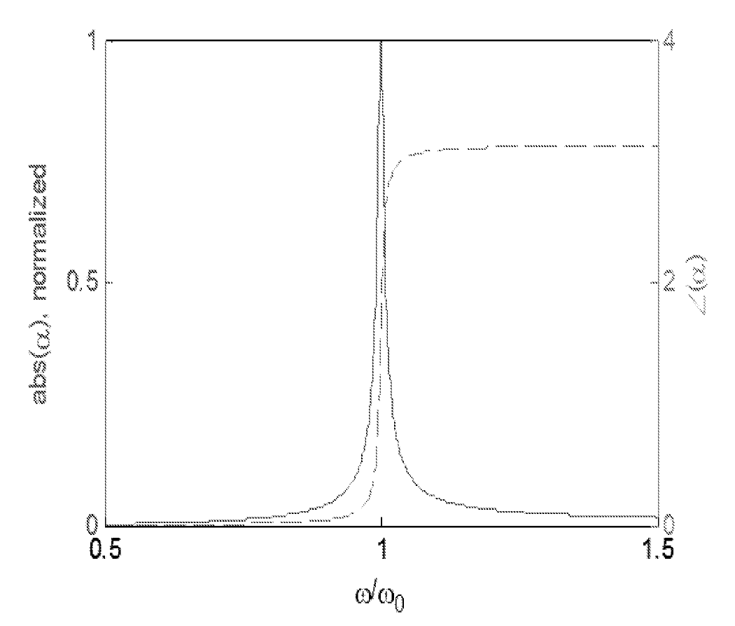

The amplitude (normalized) and phase response of such an oscillator as a function of ω/ω₀(normalized by ω₀) are shown in FIG. 1 for a dipole with Q=50. Particularly, FIG. 1 illustrates a graph showing amplitude (normalized) and phase of a lorentzian resonator as a function of the operation frequency ω.

Once an operation frequency ω is chosen, a dipole with resonance frequency ω may be provided to have these amplitudes and phases. Any phase between 0 and Π OR any amplitude between 0 and 1 may be accessed by choosing the appropriate ω₀ of the dipole forming a given pixel—but not all combinations of the two are possible.

Since the hologram is more important for its operation than its amplitude, a phase hologram is disclosed such that its amplitude distribution is forced to obtain the lorentzian relationship. Because the dipoles' phase does not cover the entire 0 to 2Π region, for simplicity anything above Π can be rounded to 0 or Π (this region can be accessed by modifying the reference wave such that it includes fields incident in various polarizations).

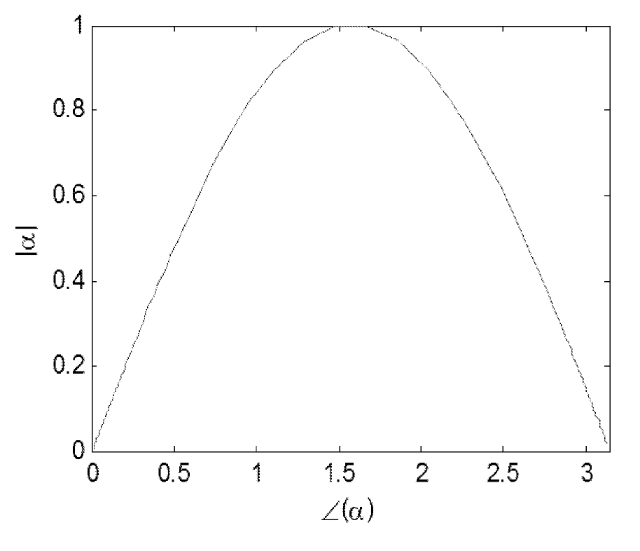

The magnitude of ∝ may be solved in terms of its phase. Here, an interpolation technique is used to find the data points from the curve plotted in FIG. 2. Particularly, FIG. 2 illustrates a graph showing the magnitude of a lorentzian dipole's polarizability as a function of its phase.

The electric field illuminating location r̅ the scene can be computed through superposition of the fields radiated from all dipoles according to:

$$\overline{E} ( \overline{r} ) = i \frac{ {ωμ}_{0}}{4 Π} {\sum }_{n} ( {\overline{m}}_{n} \times \hat{r} ) ( \frac{ik}{\vert {R}_{n} \vert} - \frac{1}{{\vert {R}_{n} \vert}^{2}} ) exp ( ik \vert {R}_{n} \vert )$$

where Rₙ=r̅−ρₙ is the vector between the n^{th} dipole at ρₙ and location in the r̅ scene.

In the Fraunhofer limit Eᵣ≈0 and E₀ is proportional to ∝:

$$E ∝ ∝ \frac{exp ( - jkr )}{r}$$

such that the resulting irradiance pattern I can be approximated from a collection of dipoles using the FT of ∝ according to

I=|FT(∝)|²

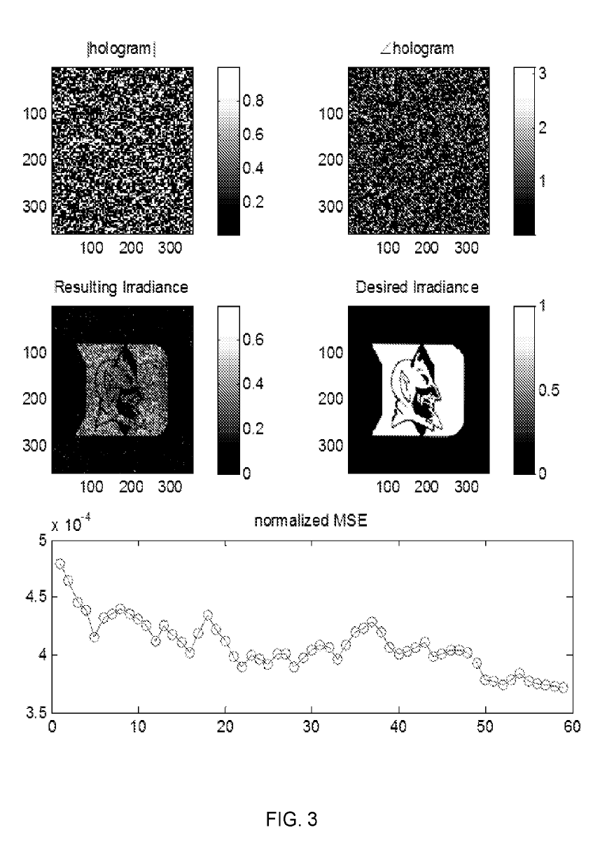

At this stage, the iterative Gerchberg-Saxton (GS) algorithm may be used with the following constraints on the hologram:

$$1. {H}^{′} = \vert H \vert {e}^{j φ H}$$

$$2. if ( - \frac{Π}{2} ) \leq {φ}_{H} \leq then {φ}_{H} = 0$$

$$3. if ( - Π ) \leq {φ}_{H} \leq ( - \frac{Π}{2} ) then {φ}_{H} = Π$$

$$4. \vert {H}^{2} \vert = L ( {φ}_{{H}^{′}} ) where L is the Lorentizian function$$

where ϕ_{H} refers to the hologram's phase, H′ is the constrained hologram, and L(ϕ_{H′}) gives the magnitude of hologram given its phase and a lorentzian relationship. The GS algorithm can be initiated with the desired irradiance pattern (the resulting mode) and a random phase distribution, as shown in FIG. 3 which outlines the GS algorithm's steps. Particularly, FIG. 3 provides an example of a fabricatable hologram constructed using lorentzian dipoles to produce a specific irradiance pattern.

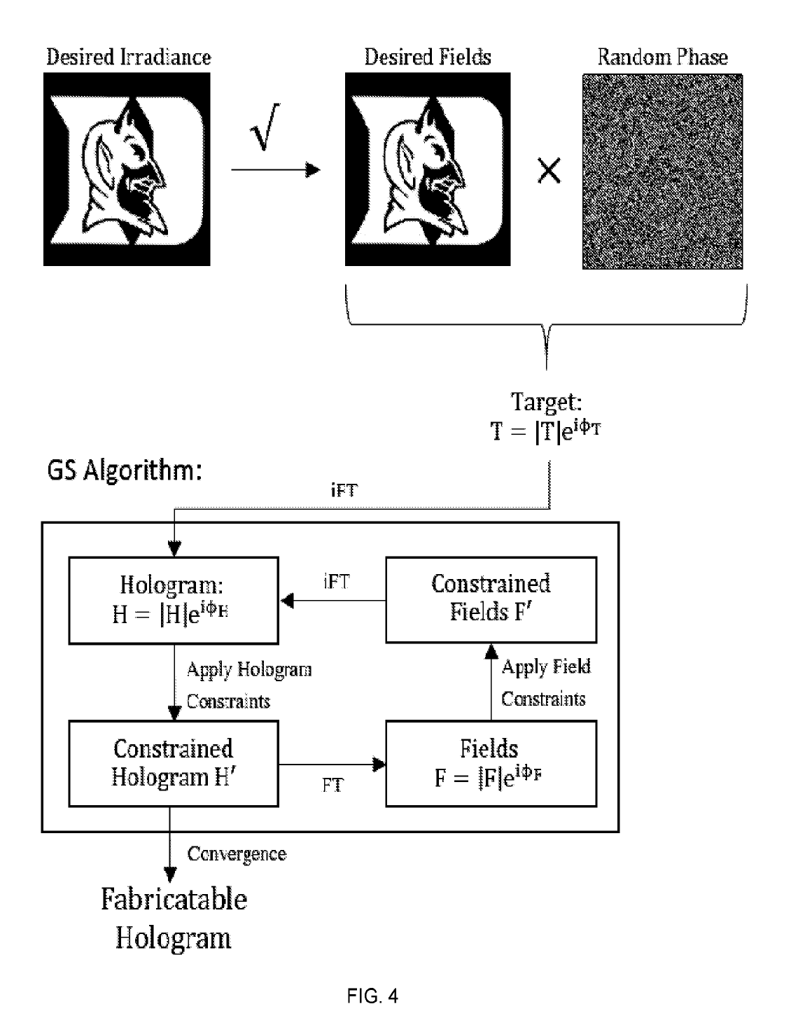

As an example of the utility of a lorentzian metamaterial hologram, a complex hologram is provided using the iterative GS algorithm and the constraints outlines herein to yield a “Duke Blue Devil” irradiance pattern. The hologram's phase and magnitude, as well as the desired and resulting irradiance pattern (and the mean-squared-error at each iteration step) are shown in FIG. 4, which illustrates steps taken by the GS algorithm.

As described herein, upon choosing an operation frequency ω, the resonance frequency distribution ω₀(ρ) of a dispersive metamaterial array can be chosen to form a hologram that couples appropriately to a reference wave and yields a desired radiation pattern. In a similar fashion, multiple frequency-diverse holograms may be provided that use the same metamaterial array. Assuming N holograms with N desired radiation patterns, each produced at operation frequency ω₀(ρ) to minimize the overall error between the desired and resulting radiation patterns across the N holograms. Then, by sweeping the frequency of the reference wave from ω₁ to ω_{N}, a different hologram is realized at each frequency ωᵢ and a new radiation pattern is observed.

In some described embodiments it is assumed that the response of passive elements varies only as a function of frequency. Alternatively, if there is tunable control of the elements, then relying on different operation frequencies to yield different radiation patterns may not be needed. Instead, an array of identical elements can be fabricated and the state of each element determined based on the value of the hologram's pixel at the location of that element.

An example list of tuning techniques and their implications on hologram design follows:

1. Binary on/off switching of the hologram's pixels, such that the hologram is purely an amplitude hologram and the state of each element is selected based on the magnitude and phase of the underlying reference wave.

2. Grayscale control of the pixels' amplitude, which can result in an amplitude hologram but with finer control.

3. Control of the pixels' phase, for example by shifting its resonance frequency. This technique can enable phase holograms in which both the reference wave's phase and the pixel's phase (and amplitudes) determine the state of a pixel in the hologram.

In accordance with embodiments, a multi-aperture system can be configured such that multiple holographic apertures operate together. In this manner, the entire aperture array can act as a hologram to form a desired radiation pattern. A second low-resolution imaging system may be present to interrogate the entire field-of-view and identify regions-of-interest (ROI) where the holographically-designed modes may be directed. For this reason, it may be desirable that the holographic imager form a sparse array that can occupy the same area as other existing imaging systems without blocking their field of view.

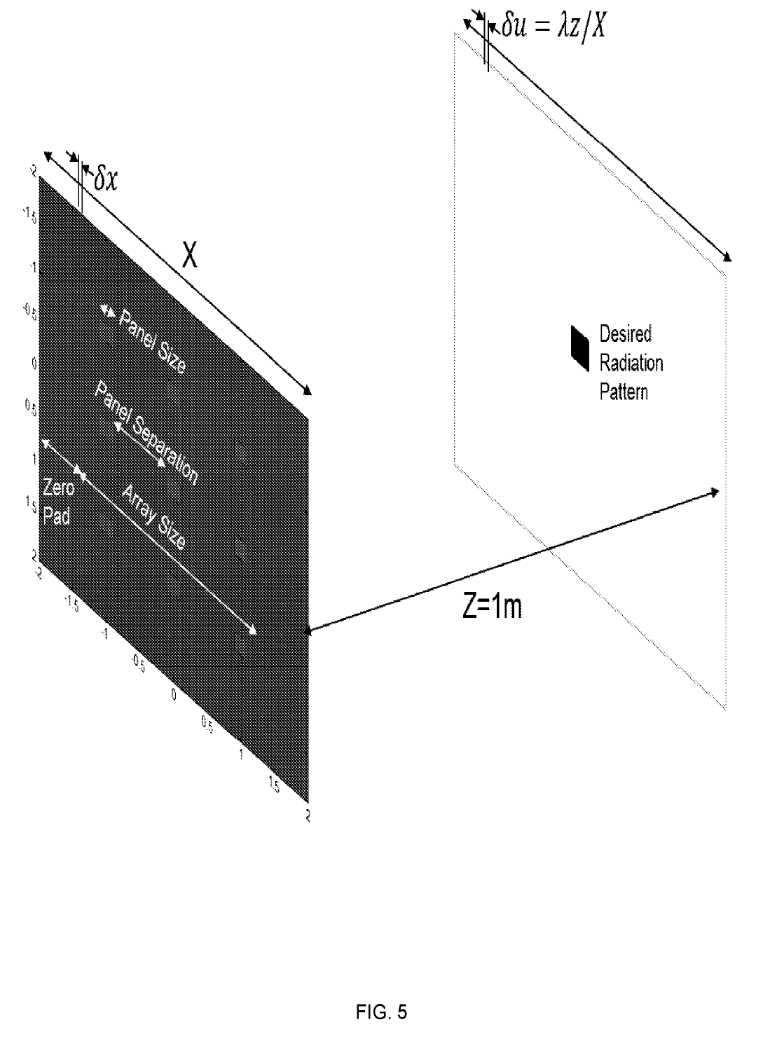

As a demonstration, a spare aperture array including a 3×3 set of individual apertures is provided. For example, FIG. 5 illustrates a perspective view of an example of nine metamaterial apertures composing a sparse holographic array. The array is configured to illuminate a small region 1 meter away. Each aperture is 20 cm in size and has elements that are 1 mm×1 mm in size, although it should be noted that the apertures may be any suitable size and any suitable arrangement different than the arrange shown in FIG. 5. Referring to FIG. 5, the sparse array is configured to produce an illuminating pattern spanning a ±10 cm region of space (in cross-range) at a distance of 1 m away as shown. The individual apertures are separated by 40 cm to form an array that is 2 m in size as determined according to the desired resolution.

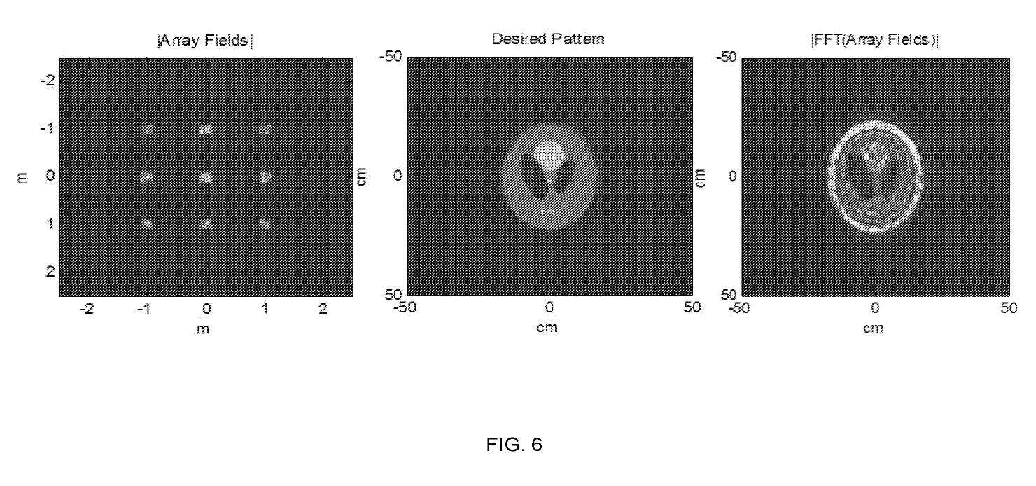

In this example, the abilities of a sparse array to generate a desired directive radiation pattern are demonstrated, so it is assumed that the element's amplitude and phase and unconstrained. The desired radiation pattern is the phantom mask, and the GS algorithm was used to determine the ideal field (complex amplitude and phase) at each pixel. In this example, one constraint in place is that the fields between apertures—corresponding to locations with no radiative elements—are set equal to zero. The result is shown in FIG. 6, where a satisfying beam pattern that closely matches the desired phantom shape is observed. Particularly, FIG. 6 illustrates images showing desired and computed radiation patterns of a holographic sparse array with no constraints on the pixel's fields.

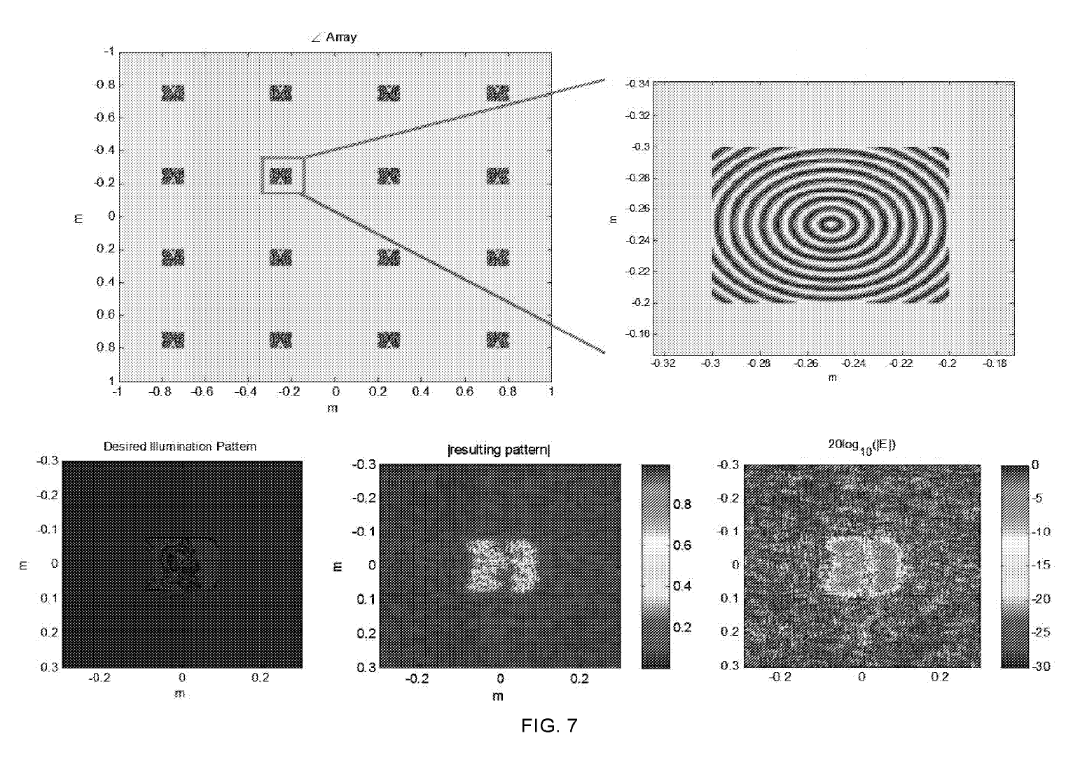

In another example scenario, holographic apertures built from tunable on/off pixels are used. Also, each pixel is exposed to a reference wave of cylindrical nature, such as the fields radiating from a probe at its center. An example is provided in FIG. 7, which illustrates images of a spare holographic array with binary on/off elements and a cylindrical reference wave. The panels in this example span a 2 m×2 m area, but as opposed to the previous example, 16 panels of size 10 cm each are used. The elements are again 1 mm in size, and the GS algorithm applies the constraint that the only elements which are switched “on” are those whose reference wave is within a predetermined threshold of the ideal hologram's phase. The desired radiation pattern is designed to be the “Duke logo,” and the resulting irradiance pattern is shown in linear and dB scales in FIG. 7.

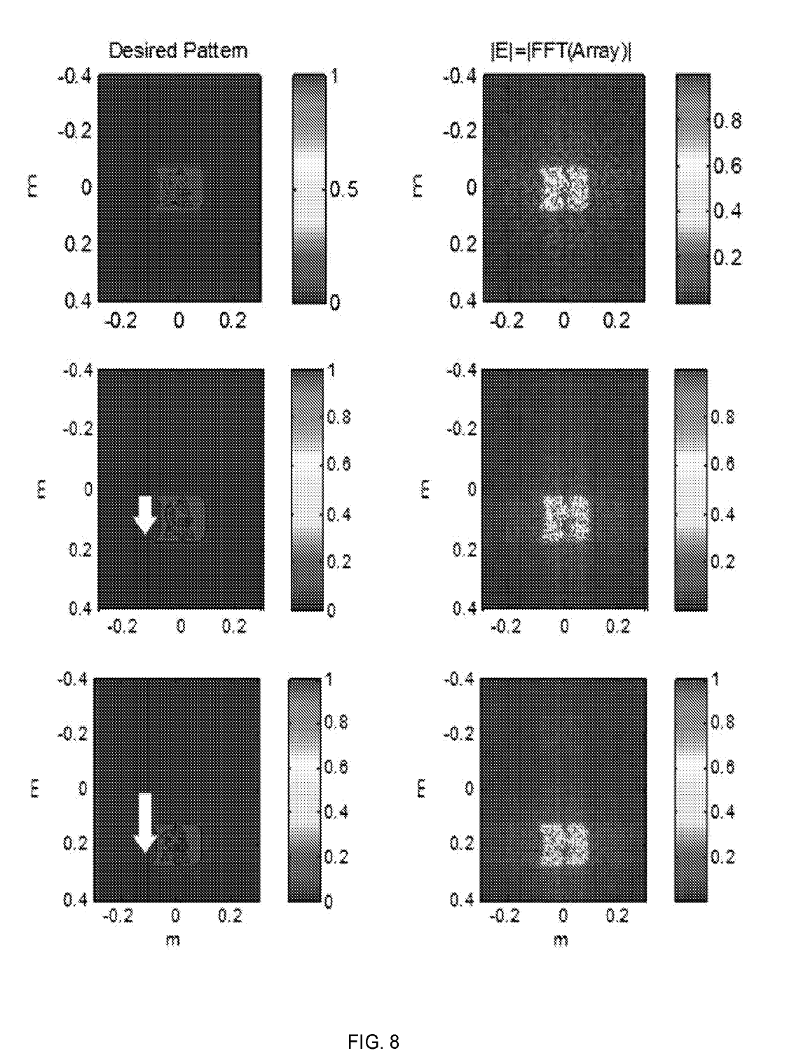

To demonstrate the array's ability to move the localized beam in space while still maintaining its directivity, the example is repeated but the Duke logo pattern is moved by 10 cm and 20 cm along the vertical axis. The results are shown in FIG. 8, and exhibit it is possible to modify the radiation pattern solely by switching “on” a different subset of the hologram's pixels. Particularly, the results shown in FIG. 8 demonstrate that a sparse holographic array with on/off binary elements can move a localized radiation pattern to different locations in the scene without using any mechanically-moving parts.

In accordance with embodiments, apertures in an array can be configured to operate as independent holograms instead of forming a large hologram collectively. This configuration can be useful at higher frequencies, where the aperture needed to illuminate a smaller subregion on a target can be relatively small. However, to achieve significant resolution the effective aperture may be relatively large, since the imaging resolution relates directly to the aperture size. Through the use of computational imaging techniques, an imaging system can be realized by combining a small, dynamic aperture that illuminates only the targeted subregion, and then collecting radiation scattered from that subregion with an array of antennas dispersed over a larger area. The dynamic aperture may be a metamaterial based aperture tuned by any suitable number of mechanisms. In an example, a dynamic antenna may be utilized in which liquid crystal technology is used to implement dynamic control over the position and characteristics of a beam. In another example, a suitable semiconductor technique may be used to implement dynamic control over the position and characteristics of a beam. Suitable semiconductor techniques may be used to provide dynamic control to the aperture. Further, suitable devices may be used to control illumination regions, including, but not limited to, phased arrays, electronically scanned antennas (AESAs), mechanically-steered dish antennas, or the like.

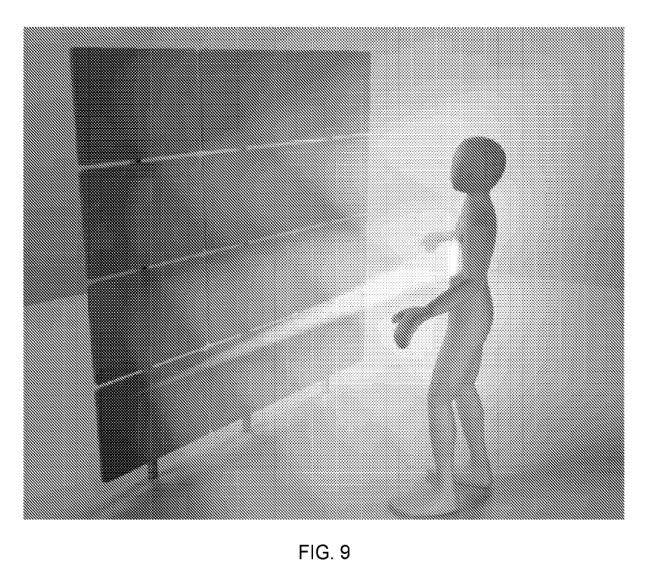

In the context of a metamaterial imaging system, a spotlight imager can be used in conjunction with other approaches to achieve a multi-sensor configuration. FIG. 9 is an image showing that the broader field of view is illuminated by a lower frequency imager, while a spotlight system interrogates a particular subregion of interest.

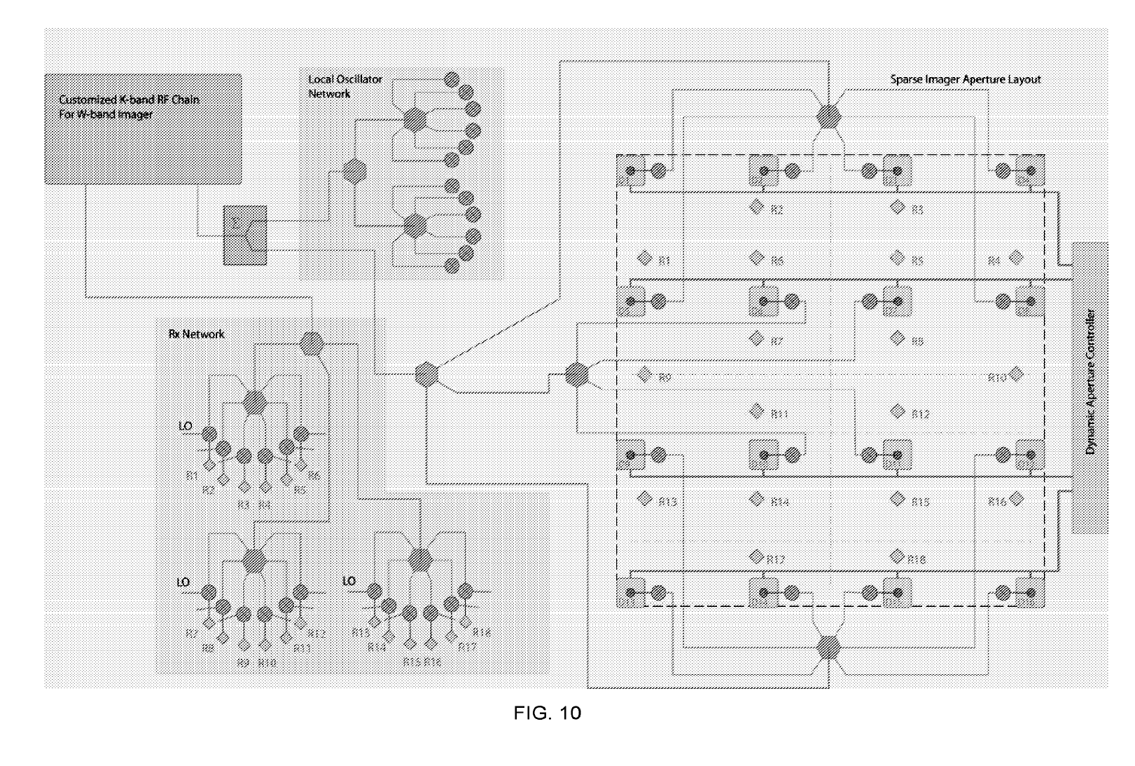

FIG. 10 illustrates a schematic diagram of an example spotlight imaging W-band system in accordance with embodiments of the present disclosure. Referring to FIG. 10, the system includes dynamic apertures (D1, D2, etc.) and receive antennas (R1, R2, etc.). The dynamic apertures are assumed to be able to steer a diffraction limited beam around the field-of-view, illuminating subregions of interest. The number of dynamic apertures may be set by usage and configuration. Further, the number of receive antennas may be set by a desired extent of the illuminated subregion. The system can make use of switches to sequentially transmit on the various apertures and receive on the various antennas. It is noted that system shown in FIG. 10 should be considered exemplary and should not be construed to be limiting various system that can be made in accordance with the present disclosure using suitable techniques.

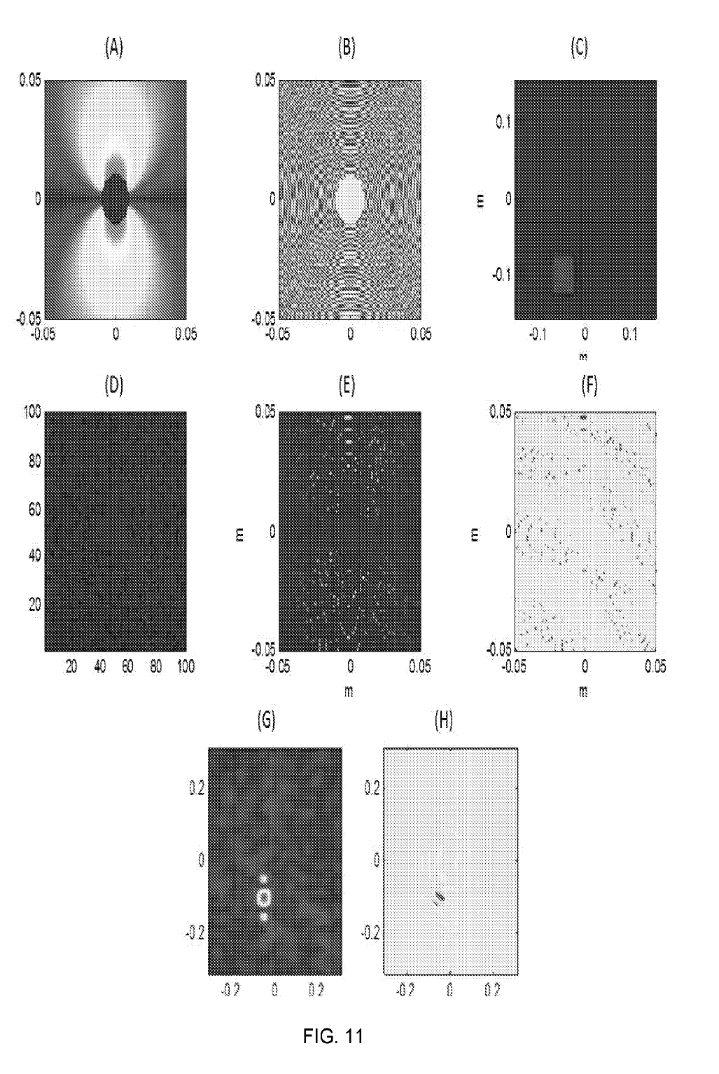

FIG. 11 illustrates how a single dynamically-tuned metamaterial aperture can form a localized beam pattern off of its optical axis. In this example it is assumed that the dynamic antennas are implemented using parallel-plate metamaterial apertures, and that the aperture's elements are dynamically tuned in a binary on-off fashion. Referring to FIG. 11, images show the results of using individual apertures as holograms in a spotlight imaging system. Images A and B in FIG. 11 shows the magnitude and phase of a guided mode between two parallel plates, which serve as a reference wave. Image C shows the result of a desired spotlight beam illuminating a localized region in space. Image D shows the resulting holographic mask to be applied to the dynamic aperture. Images E and F show the resulting magnitude and phase of the aperture's elements when the holographic mask is applied. Images G and H show the magnitude and phase of the radiation pattern, forming a spotlight in the desired direction.

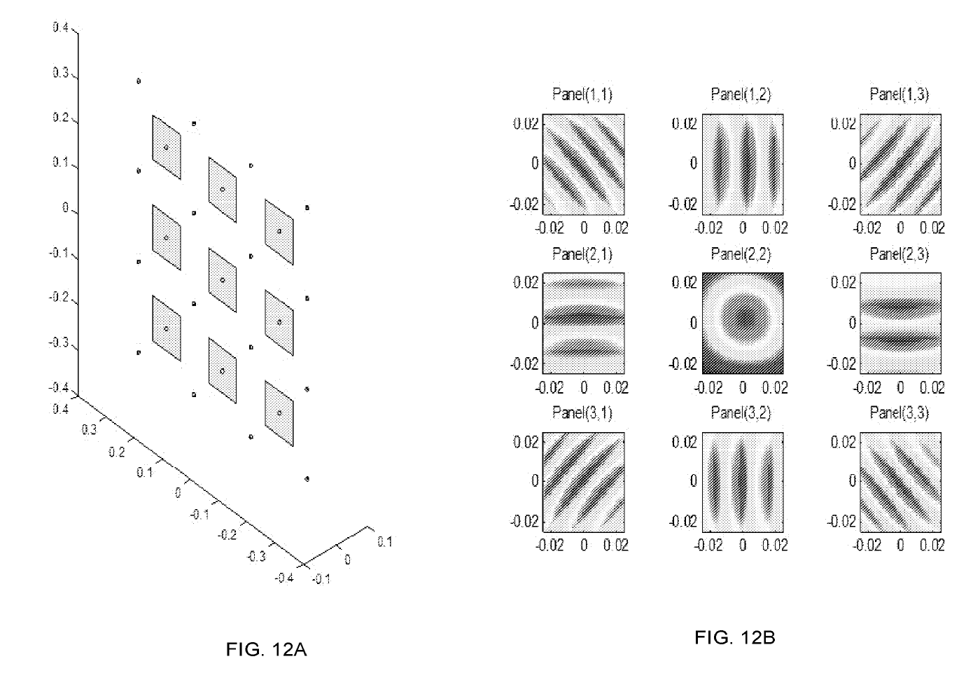

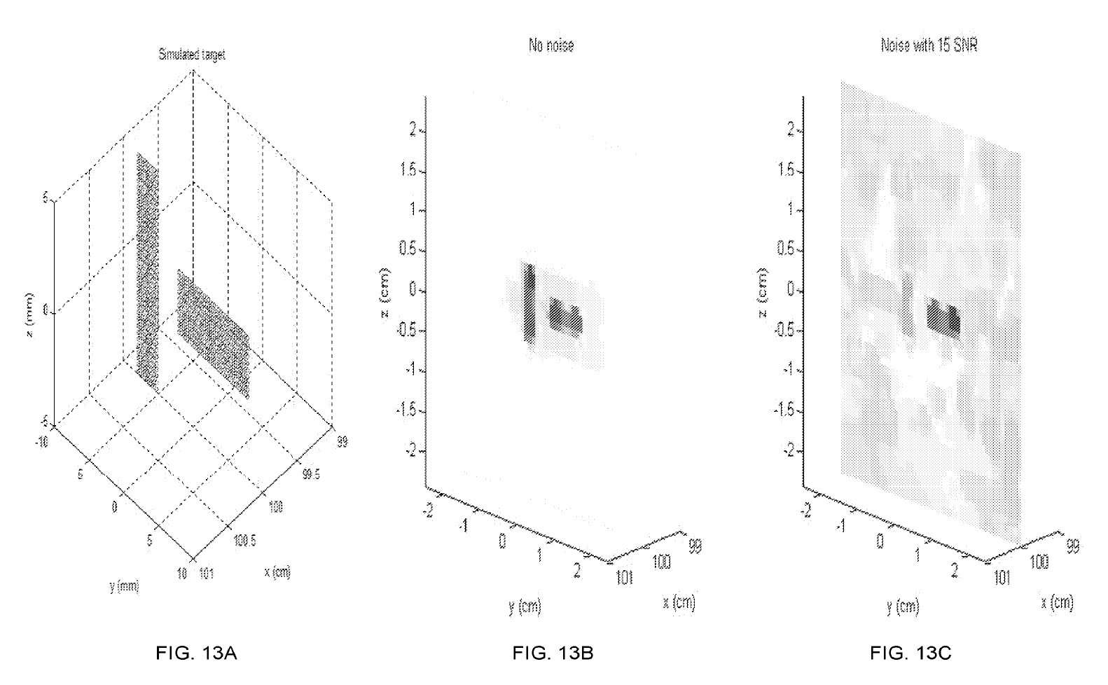

To demonstrate the imaging ability of such a spotlight system, an imaging system having 3×3 dynamically tuned metamaterial apertures serving as transmitters to illuminate the scene, and 4×4 low-gain probes serving as receivers to capture backscatter from the scene. The transmitter and receiver array is shown in FIGS. 12A and 12B, along with the radiation patterns (phase normalized by magnitude) from each panel. For this example, each of the transmitter apertures were configured to illuminate a small region at the origin a distance of 1 m away. FIG. 12A illustrates a diagram of a sparse holographic imaging system in accordance with embodiments of the present disclosure. Here 3×3 dynamic apertures serve as transmitters and 4×4 low-gain probes serve as receivers. FIG. 12B show the radiation pattern of each panel (phase normalized by magnitude) calculated around the origin 1 meter away. The simulated target in this example included a horizontal bar and a vertical bar. Simulated reconstructions in the presence of noise successfully estimated the reflective bars, as shown in FIGS. 13A-13C. FIG. 13A depicts the simulated target, lm away from the apertures, and having a vertical bar and a horizontal bar. FIG. 13B depicts noiseless reconstructions from measurements utilizing 9 transmitter apertures and 16 receiver apertures. FIG. 13C depicts reconstructions in the presence of noise with 15 dB SNR.

Any patents or publications mentioned in this specification are indicative of the levels of those skilled in the art to which the present subject matter pertains. These patents and publications are herein incorporated by reference to the same extent as if each individual publication was specifically and individually indicated to be incorporated by reference.

One skilled in the art will readily appreciate that the present subject matter is well adapted to carry out the objects and obtain the ends and advantages mentioned, as well as those inherent therein. The present examples along with the methods described herein are presently representative of various embodiments, are exemplary, and are not intended as limitations on the scope of the present subject matter. Changes therein and other uses will occur to those skilled in the art which are encompassed within the spirit of the present subject matter as defined by the scope of the claims.

What is claimed is:

1. An imaging system comprising:
a plurality of metamaterial elements being spaced apart and configured to respond to an electromagnetic field for radiating in a predetermined pattern to illuminate a scene; and
at least one antenna configured to generate a signal for imaging based on the illuminated scene.

2. The imaging system of claim 1, wherein the metamaterial element are each one of an aperture and a resonator.

3. The imaging system of claim 1, wherein the metamaterial elements are configured to be switched on and off.

4. The imaging system of claim 1, further comprising a waveguide configured to provide the electromagnetic field.

5. The imaging system of claim 1, wherein the waveguide is configured to provide the electromagnetic field to control an amplitude of each metamaterial element.

6. The imaging system of claim 1, wherein the waveguide is configured to provide the electromagnetic field to control a phase of each metamaterial element.

7. The imaging system of claim 1, wherein the waveguide is configured to provide the electromagnetic field to control a subset of the metamaterial elements to activate.

8. The imaging system of claim 1, wherein the at least one antenna comprises an array of antennas.

9. The imaging system of claim 1, wherein the at least one antenna comprises one of phased arrays, electronically scanned antennas (AESAs), and mechanically steered dish antennas.

10. The imaging system of claim 1, wherein the at least one antenna is configured to receive backscatter from the illuminated scene.

11. The imaging system of claim 1, further comprising a printed circuit board (PCB) with the metamaterial elements residing therein.

12. A method comprising:
providing a plurality of metamaterial elements being spaced apart and configured to respond to an electromagnetic field for radiating in a predetermined pattern to illuminate a scene; and
using at least one antenna to generate a signal for imaging based on the illuminated scene.

13. The method of claim 12, wherein the metamaterial element are each one of an aperture and a resonator.

14. The method of claim 12, wherein the metamaterial elements are configured to be switched on and off.

15. The method of claim 12, further comprising using a waveguide to provide the electromagnetic field.

16. The method of claim 12, further comprising using the waveguide to provide the electromagnetic field to control an amplitude of each metamaterial element.

17. The method of claim 12, further comprising using the waveguide to provide the electromagnetic field to control a phase of each metamaterial element.

18. The method of claim 12, further comprising using the waveguide to provide the electromagnetic field to control a subset of the metamaterial elements to activate.

19. The method of claim 12, wherein the at least one antenna comprises an array of antennas.

20. The method of claim 12, wherein the at least one antenna comprises one of phased arrays, electronically scanned antennas (AESAs), and mechanically steered dish antennas.

21. The method of claim 12, further comprising using the at least one antenna to receive backscatter from the illuminated scene.

22. The method of claim 12, further comprising providing a printed circuit board (PCB) with the metamaterial elements residing therein.
